(19) United States
(12) Patent Application Publication
(10) Pub. No.: US 2026/0162188 A1
(43) Pub. Date: Jun. 11, 2026

(54) Artificial Intelligence (AI) for Prediction and/or Prevention of Home Loss and/or Damage

(71) Applicant: STATE FARM MUTUAL AUTOMOBILE INSURANCE COMPANY, Bloomington, IL (US)

(72) Inventors: Michael Niehaus, Glendale, AZ (US); Rick J. Campbell, Bloomington, IL (US); Julie K. Fritz, Bloomington, IL (US)

(21) Appl. No.: 19/416,195

(22) Filed: Dec. 11, 2025

Related U.S. Application Data
(60) Provisional application No. 63/730,622, filed on Dec. 11, 2024.

(51) Int. Cl. G06Q 40/08; G06N 20/00

(52) U.S. Cl. CPC G06Q 40/09; G06N 20/00

(57) ABSTRACT

The following relates generally to creating customized training datasets for improved training of artificial intelligence (AI) and/or machine learning (ML) models, particularly in the insurance industry. In some embodiments, one or more processors are configured to: (1) construct a customized training dataset; (2) train the ML model by inputting the customized training dataset into the ML model; and/or (3) determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim.

### CROSS REFERENCE TO RELATED APPLICATIONS

This application claims the benefit of U.S. Provisional Application No. 63/730,622, entitled “Improved Artificial Intelligence (AI) for Prediction and/or Prevention of Home Loss and/or Damage” (filed Dec. 11, 2024), the entirety of which is incorporated by reference herein.

### FIELD

The present disclosure generally relates to creating customized training datasets for improved training of artificial intelligence (AI) and/or machine learning (ML) models. The present disclosure also relates generally to using an AI and/or ML model to determine any of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, (ix) probability of the customer placing an insurance claim, and/or (x) insights.

### BACKGROUND

Insurance companies may use AI and/or ML to make certain determinations (e.g., determine a probability of a loss by cause of loss, etc.). However, many current systems may produce inaccurate results.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

Broadly speaking, systems and methods described herein may construct a customized (e.g., “positioned”) dataset for individual insurance customers. In some examples, the customized training datasets may be used to train individual AI and/or ML models for each insurance customer. Customizing the dataset for each customer, and then building the ML models based upon the customized training datasets advantageously greatly improve the accuracy of the ML models.

In one aspect, a computer-implemented method for training and/or using a machine learning (ML) model to make an insurance-related determination may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) constructing, via one or more processors, a customized training dataset by: (A) receiving a geographic location of a customer; (B) receiving a base insurance dataset including data of a plurality of insurance customers; and/or (C) building the customized training dataset by removing data from the base insurance dataset based upon: (i) respective geographic distances between the geographic location of the customer and respective insurance customers of the plurality of insurance customers, and/or (ii) a temporal constraint; (2) training, via the one or more processors, the ML model by inputting the customized training dataset into the ML model; and/or (3) determining, via the one or more processors, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim. The method may include additional, fewer, or alternate actions, including those discussed elsewhere herein.

In another aspect, a computer device configured for training and/or using a machine learning (ML) model to make an insurance-related determination may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) construct a customized training dataset by: (A) receiving a geographic location of a customer; (B) receiving a base insurance dataset including data of a plurality of insurance customers; and/or (C) building the customized training dataset by removing data from the base insurance dataset based upon: (i) respective geographic distances between the geographic location of the customer and respective insurance customers of the plurality of insurance customers, and/or (ii) a temporal constraint; (2) train the ML model by inputting the customized training dataset into the ML model; and/or (3) determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight (e.g., a recommendation to complete a home improvement project, etc.), (vi) probability that customer will perform insight, (vii) estimated cost of performed insight, (viii) customer segmentation, and/or (ix) probability of the customer placing an insurance claim. The computer device may include additional, less, or alternate functionality, including that discussed elsewhere herein.

In yet another aspect, a computer system configured for training and/or using a machine learning (ML) model to make an insurance-related determination may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) construct a customized training dataset by: (A) receiving a geographic location of a customer; (B) receiving a base insurance dataset including data of a plurality of insurance customers; and/or (C) building the customized training dataset by removing data from the base insurance dataset based upon: (i) respective geographic distances between the geographic location of the customer and respective insurance customers of the plurality of insurance customers, and/or (ii) a temporal constraint; (2) train the ML model by inputting the customized training dataset into the ML model; and/or (3) determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for training and/or using a machine learning (ML) model to make an insurance-related determination.

FIG. 2 depicts a flow diagram representing an exemplary overall computer-implemented method for training and/or using a ML model to make an insurance-related determination.

FIG. 3 depicts an exemplary table of probability of a loss by cause of loss.

FIG. 4 depicts an exemplary table of cost estimate by cause of loss.

FIG. 5 depicts a flow diagram representing a more detailed exemplary computer-implemented method for training and/or using a ML model to make an insurance-related determination.

FIG. 6 depicts an exemplary Directed Acyclic Graph (DAG).

FIG. 7 depicts an exemplary flowchart for fitting, updating and evolving mixture features according to the adaptive mixture features (AMF) methodology, including a two phased approach.

FIG. 8 depicts a block diagram of an exemplary machine learning modeling method for training and evaluating exemplary machine learning model(s).

FIG. 9 depicts an exemplary screen depicting ranked insights.

### DETAILED DESCRIPTION

Broadly speaking, systems and methods described herein may construct a customized (e.g., “positioned”) dataset for individual insurance customers. In some examples, the customized training datasets may be used to train individual AI and/or ML models for each insurance customer. Examples of insurance-related determinations that the ML algorithms may be trained to make include: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, (ix) probability of the customer placing an insurance claim, and/or (x) an insight. Customizing the dataset for each customer, and then building the ML models based upon the customized training datasets advantageously greatly improve the accuracy of the ML models.

To further describe this technical advantage, consider that prior electronic insurance systems trained an ML model using a structure, p(x). In contrast, techniques described herein effectively train an ML model using a conditional structure p(y|X), rather than p(x). That is, by first creating a customized training dataset for each insurance customer, the techniques described herein build a structure p(y|X) to train on. This reduces the problem of miss-specification in training the ML model. It should be appreciated that the problem of miss-specification refers to a situation where the ML model is incorrect or incomplete due the way it has been specified and/or formulated. This typically occurs when key assumptions about the data, relationships, or structure of the ML model are violated or when variables or interactions are omitted.

To further explain, using Bayesian techniques, information from p(x) is typically incorporated by the specification of a prior p (0) with p(y, x) in regression settings modeled as a multivariate Gaussian by way of a Gibbs sampler subject to model miss-specification and precision. The specification of a suitable prior is a hard technical problem with only minor miss-specifications often leading to undesirable results. Many past techniques have provided tools to attempt to address this problem under this restrictive Gaussian assumption with the specification of informative mixture priors, non-informative priors, or regularization methods.

Some examples discussed herein include a flexible, hybrid Bayesian solution for training the ML model, which incorporate information on the unobserved p(x) by positioning the observed training sample within fitted distributions contained in p(x). Working with the conditional model p(y|X), some examples discussed herein incorporate information about the structure of p(x) not through the specification of a prior and potentially complicated full Bayesian model, but as a transformation of the observed data itself. Transformation of the data circumvents the hard and restrictive problems related to model miss-specification inherent with the Bayesian approach while still incorporating p(x) of the predictors.

### Exemplary Computer System

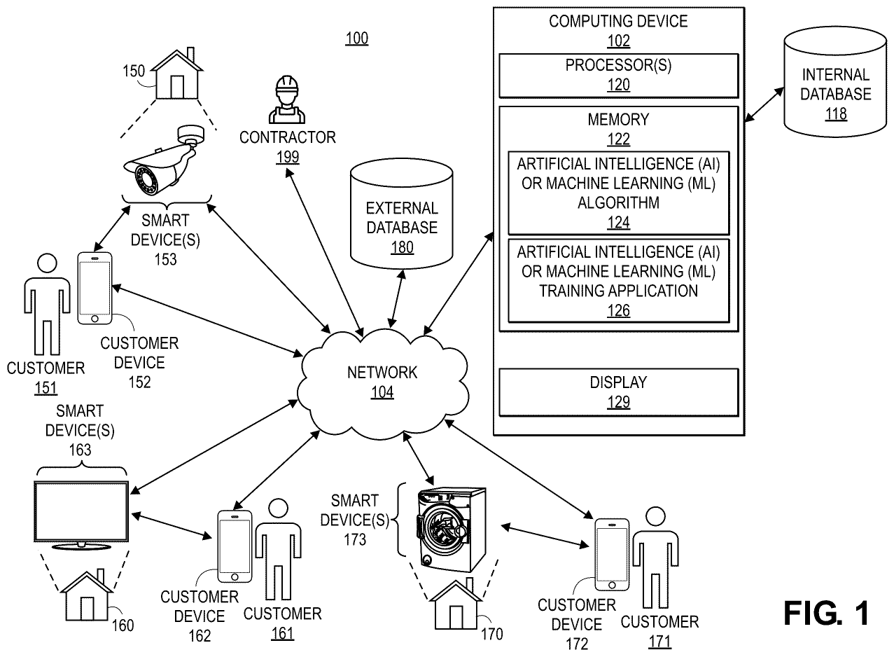

FIG. 1 illustrates an exemplary computer system 100 for using a machine learning (ML) model to predict, inter alia, an insurance claim in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as artificial intelligence (AI) or machine learning (ML) algorithm 124, and/or AI or ML training application 126. The computing device 102 may further include display 129.

In some examples, an insurance company owns the computing device 102, and the insurance company may provide insurance, such as homeowners or renters insurance, to the customer 151 (e.g., an insurance customer of the insurance company, etc.). Such an insurance company may provide recommendations for insights (e.g., home improvement projects, etc.) to the customer 151, 161, 171. Completing the insights may benefit both the customer 151, 161, 171 and the insurance company. For example, if an insight to complete installing a sump pump is completed, it is less likely that the basement of the home 150, 160, 170 will flood, which benefits both the customer 151, 161, 171 and the insurance company. In some such examples, the app provided by the insurance company may provide discounts on and/or recommendations for products and/or services to complete the insight. Additionally or alternatively, the app may provide discounts on insurance to reward the customer for well maintaining their home 150, 160, 170.

Additionally or alternatively, it may be useful for the insurance company to generate a home score for the home 150. In some embodiments, the home score may be generated, at least in part, from sensor data from the home 150, 160, 170. Such sensor data may come from smart device(s) 153, 163, 173. In some such examples, completing an insight may improve the home score and/or any of the subscores. Furthermore, in some embodiments, a tutorial may be provided explaining how to complete the insight.

Any of the customers 151, 161, 171 may use their respective customer devices 152, 162, 172 to view the recommended insights, and/or home score(s) (e.g., via a display of the customer device 152, 162, 172). The customer devices 152, 162, 172 may be any suitable device, such as a computer, a mobile device, a smartphone, a laptop, a phablet, a chatbot or voice bot, etc. The customer device 152, 162, 172 may include one or more display devices, one or more processors, one or more memories, etc.

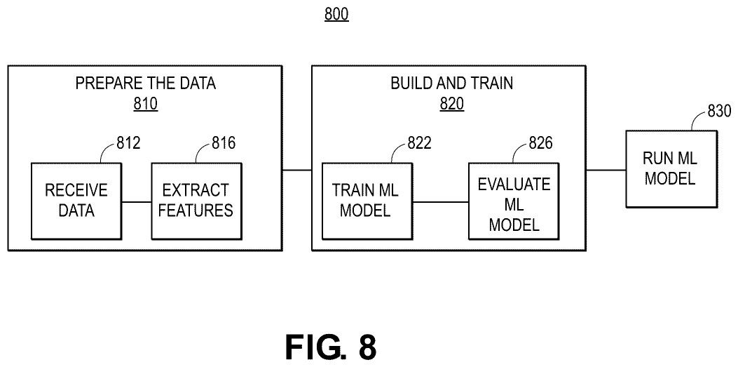

The exemplary computer system 100 may also include external database 180 and internal database 118. Examples of the data stored by the external database 180 and/or internal database 118 include historical information used to train AI and/or ML models and/or algorithms, such as discussed with respect to FIG. 8.

In addition, further regarding the example system 100, the illustrated exemplary components may be configured to communicate, e.g., via a network 104 (which may be a wired or wireless network, such as the internet), with any other component. Furthermore, although the example system 100 illustrates certain number(s) of each of the components, any number of the example components are contemplated (e.g., any number of customers, customer devices, homes, smart devices, computing devices, databases, contractors, etc.).

### Exemplary Overall Process

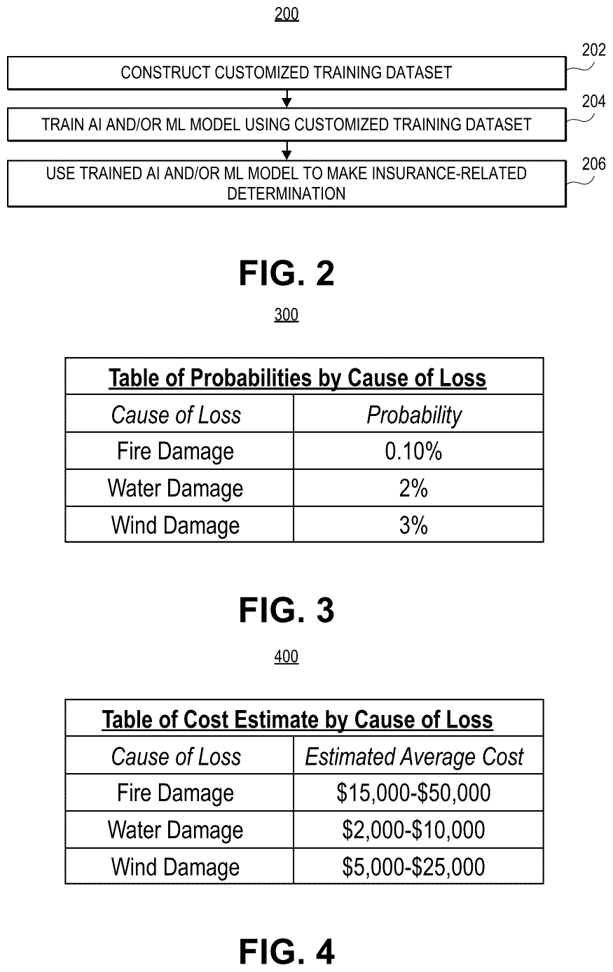

FIG. 2 depicts a flow diagram representing an exemplary overall computer-implemented method 200 for training and/or using a ML model to make an insurance-related determination. The exemplary method 200 may be implemented by a computing environment 100, for example, including the computing device 102, the customer device(s) 152, 162, 172, and/or any suitable device including those discussed elsewhere herein, such as one or more local or remote processors, transceivers, memory units, sensors, mobile devices, unmanned aerial vehicles (e.g., drones), etc.

The exemplary computer-implemented method 200 may begin at block 202 when the one or more processors 120 construct a customized training dataset. The customized training dataset may be “positioned” such that it is customized specifically for an insurance customer, such as customer 151, 161, 171. By creating the customized training dataset, the techniques described herein may train an AI and/or ML model specifically tailored to the individual customer. Such a specifically tailored model produces more accurate determinations, thereby improving technical functioning.

At block 204, the one or more processors 120 may train (e.g., via the AI or ML algorithm 124 and/or the AI or ML training application 126) an AI and/or ML model using the customized training dataset to thereby produce an AI and/or ML model for a specific customer. The training will be described in more detail elsewhere herein (e.g., with respect to FIGS. 7-8)

At block 206, the one or more processors 120 may use the trained AI and/or ML model to make an insurance-related determination(s). Examples of the insurance-related determinations include: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, (ix) probability of the customer placing an insurance claim, and/or (x) an insight.

The output of the AI and/or ML algorithm (e.g., the determination(s)) may be in any suitable form. Regarding (i) above, in some examples, the probability of a loss by cause of loss is output in the form of a table. In this regard, FIG. 3 depicts exemplary table 300 of probability of a loss by cause of loss.

Regarding (ii) above, in some examples, the probability of a cost estimate by cause of loss is output in the form of a table. In this regard, FIG. 4 depicts exemplary table 400 of cost estimate by cause of loss.

Any or all of (iii)-(iv) above, in some examples, may be output in the form of a table analogous to FIGS. 3 and 4.

Furthermore, it should be appreciated that a loss-comment-code may refer to a standardized identifier used to provide additional information about the nature, context, or circumstances of a loss (e.g., FIRE01 for residential fire damage, STRDMG02 for water damage due to plumbing failure, etc.).

Regarding (viii) above, in some examples, the customer segmentation may be defined by a customer engagement profile (e.g., the system learns how engaged with the app the customer is, and accordingly segments the customers into groups, etc.).

### Exemplary Computer-Implemented Methods

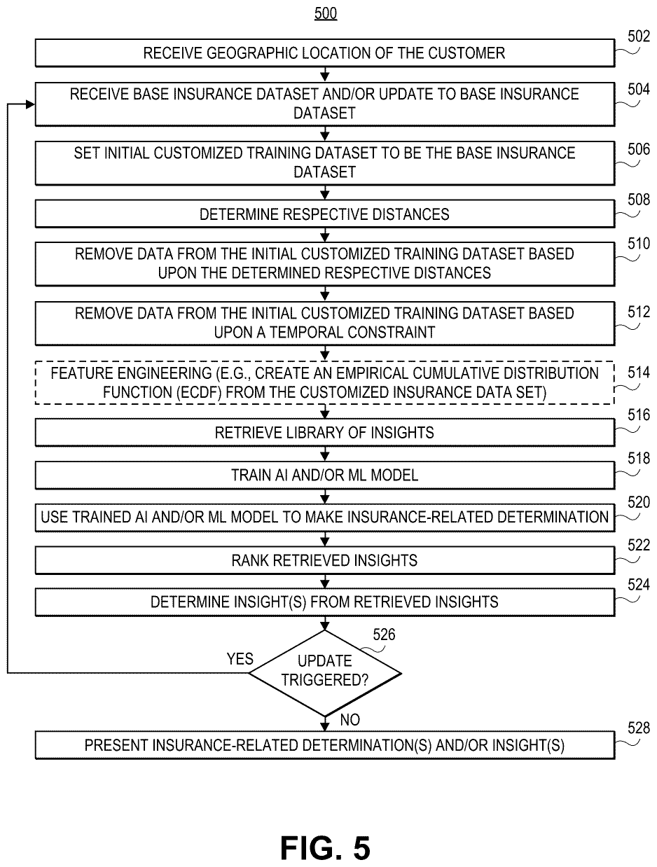

FIG. 5 illustrates a flow diagram representing an exemplary computer-implemented method or implementation 500 for training and/or using a ML model to make an insurance-related determination, which is more detailed than the exemplary computer-implemented method 200 of FIG. 2. The exemplary method 500 may be implemented by a computing environment 100, for example, including the computing device 102, the customer device(s) 152, 162, 172, and/or any suitable device including those discussed elsewhere herein, such as one or more local or remote processors, transceivers, memory units, sensors, mobile devices, unmanned aerial vehicles (e.g., drones), etc.

The exemplary computer-implemented method or implementation 400 may begin at block 502 when the one or more processors 120 receive the geographic location of the customer 151. The geographic location may be received in any suitable form, such as longitude and latitude coordinates, an address, a Global Positioning Satellite (GPS) location (e.g., including altitude information, etc.), Universal Transverse Mercator (UTM), Military Grid Reference System (MGRS), etc. The geographic location may be received from any suitable device, such as the customer device 152, the internal database 118, the external database, 180, a contractor device of the contractor 199, the memory 122, etc.

At block 504, the one or more processors 120 receive a base insurance dataset (e.g., a base dataset of insurance information, etc.). The base insurance dataset may include any insurance information, such as information of insurance customers (optionally anonymized) (e.g., geographic locations of insured properties of insurance customers [e.g., longitude/latitude coordinates, addresses, etc.]; probabilities of insurance customers to complete insights; information of insured properties of the insurance customers; demographic information of insurance customers; etc.), insurance claim information, insurance policy information, etc.

At block 506, the one or more processors 120 set an initial customized training dataset to be the received base insurance dataset. As will be seen, in some examples, from here, data is removed from the received base insurance dataset, thereby creating the customized training dataset.

At block 508, the one or more processors 120 may determine respective geographic distances between the geographic location of the customer and respective geographic locations of insurance customers from the base insurance dataset. Advantageously, to improve the customized training dataset (and thereby improve accuracy of the system), the respective geographic distances may be determined by determining haversine distances. For example, a respective geographic distance may be calculated by:

$$d = 2 rarcsine ( \sqrt{\frac{1 - cos ( Δϕ ) + cos {ϕ}_{1} \cdot cos {ϕ}_{2} \cdot ( 1 - cos ( Δλ ) )}{2}} )$$

Where:
d is the distance between the geographic location of the customer and the respective geographic location of the insurance customer from the base insurance dataset.
r is the radius of the earth.
φ₁ is the latitude of the geographic location of the customer (in radians).
φ₂ is the latitude of the respective geographic location of the insurance customer from the base insurance dataset (in radians).
λ₁ is the longitude of the geographic location of the customer (in radians).
λ₂ is the longitude of the respective geographic location of the insurance customer from the base insurance dataset (in radians).
Δφ=φ₂-φ₁ is the difference in latitude between geographic location of the customer and the geographic location of the insurance customer from the base insurance dataset.
Δλ=λ₂-λ₁ is the difference in longitude between geographic location of the customer and the geographic location of the insurance customer from the base insurance dataset.

At block 510, the one or more processors 120 may remove data from the initial customized training dataset based upon the determined respective distances. For example, data may be removed by comparing the respective geographic distances to a threshold (e.g., removing data of respective distances greater than 1000 feet, half a mile, one mile, two miles, ten miles, 100 miles, 200 miles, etc.).

At block 512, the one or more processors 120 may remove data from the customized training dataset based upon a temporal constraint. For example, data older than a predetermined time period (e.g., one day, ten days, two weeks, one month, two months, three months, six months, one year, two years, etc.) may be removed. In some examples, only particular parts of the data are removed according to the temporal constraint (e.g., insurance claim data older than the predetermined time period is removed, but other information [e.g., demographic information, other data of insurance customers and/or their properties, etc.]) is retained.

At optional block 514, the one or more processors 120 may apply feature engineering to the customized training dataset. As will be seen, techniques described herein may improve technical functioning (e.g., improve accuracy and/or interpretability, etc., of the ML algorithm) by applying aspects of feature engineering at block 514.

For example, the one or more processors 120 may create an empirical cumulative distribution function (ECDF) from the customized insurance dataset. The ECDF may be defined as:

$${F}_{n} ( x ) = \frac{1}{2} {{\sum }^{n}}_{i = 1} 1 ( {x}_{i} \leq x )$$

Where:
n is the number of datapoints in the customized insurance dataset.
1(xᵢ≤x) is an indicator function that equals 1 if xᵢ≤x, and 0 otherwise.

Additionally or alternatively to the ECDF, the following transforms may be applied at block 514: Standard Normal; Centering; Log Transform; Box-Cox Transforms; Scaling; Regularization; Principal Components; Factor Analysis; Single Value Decomposition; Neural Networks; Self Organizing Maps; and/or Model Imputation.

At block 516, the one or more processors 120 may retrieve a library of insights (e.g., from the internal database 118, the external database 180, the memory 122, and/or any other suitable source). The insight may be a recommendation for: (i) a home project to improve the home, (ii) an inspection of an aspect of the home, and/or (iii) a homeowner learning how to complete a task. However, it should be appreciated that some insights may fall into more than one of the categories (i)-(iii). The insight may be completed by a homeowner (e.g., customer 151, etc.), a contractor 199, etc. In some examples, the insights may be retrieved grouped as or labeled by peril (e.g., fire damage, water damage, wind damage, etc.). For example, insights that reduce the likelihood of a fire occurring (e.g., replacing smoke detector batteries, etc.) may be labeled as fire damage peril.

Examples of (i) above include: changing a heating, venting, and cooling (HVAC) filter; performing water heater maintenance (e.g., draining or flushing a hot water heater); cleaning faucets and/or showerheads to remove mineral deposits; troubleshooting common pest control issues (e.g., rodents, roaches, ants, etc.); servicing air conditioner; cleaning garbage disposal(s); unclogging sink, tub and/or shower drains; cleaning HVAC ducts; replacing carbon monoxide detector batteries; installing water sensors in areas at risk for leaks; etc.

Examples of (ii) above include: checking a smoke detector battery; checking toilets for running water and/or leaks around seal at base; inspecting and/or cleaning dryer vents; searching foundation and/or walls for water leaks or damage; inspecting an air conditioner; checking for drainage issues (e.g., standing water around the house, etc.); checking any or all door and window seals to ensure tight seals with no gaps; inspecting sink, tub and/or shower drains; testing carbon monoxide detectors; inspecting plumbing fixtures; etc.

Examples of (iii) above include: locating a water main valve and learning how to shut it off; locating gas main and learning how to shut it off; locating a circuit breaker box; etc.

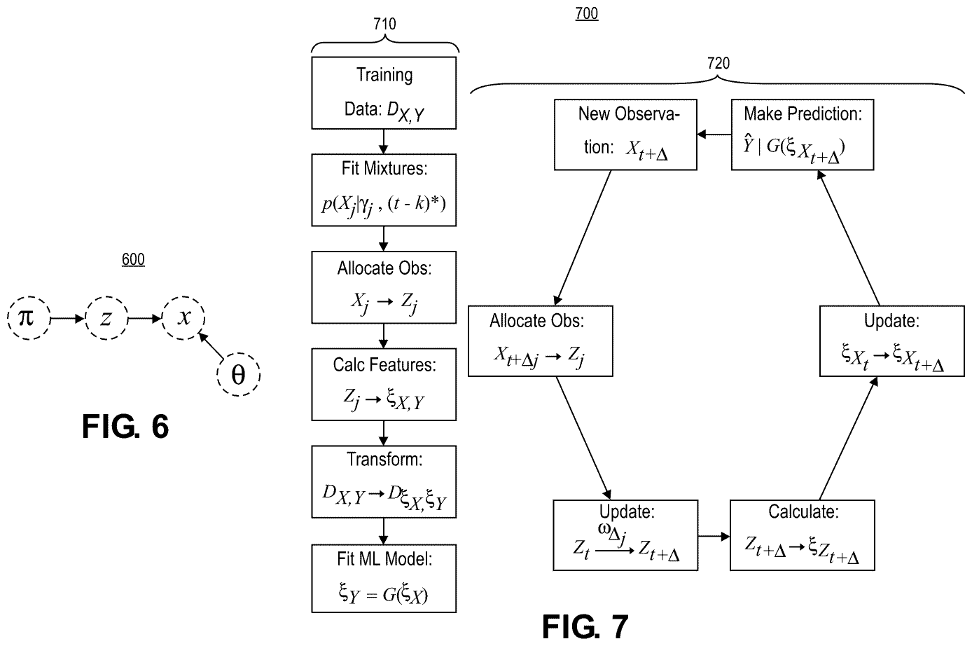

At block 518, the one or more processors 120 may train the AI and/or ML algorithm and/or model. The training process will be described in further detail elsewhere herein (e.g., with respect to FIGS. 6-8, etc.). However, it should be appreciated that the training may be based upon the customized training dataset described herein. In addition, it should be appreciated that in the training data may be used as modified at optional block 514 (e.g., by using an ECDF, etc., as the training input).

At block 520, the one or more processors 120 may use the trained AI and/or ML model to make an insurance-related determination. Examples of the insurance-related determinations are discussed elsewhere herein, and include: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, (ix) probability of the customer placing an insurance claim, and/or (x) insights.

At block 522, the one or more processors 120 may rank the retrieved insights. The ranking may be done with or without the use of AI and/or ML. If AI and/or ML is used, the same or different AI and/or ML model may be used as was trained at block 518.

In some examples, a priority score is used to rank the insights. For instance, the insights may be retrieved as labeled by peril, and a priority score may be determined for each peril. In some such examples, the priority score may be determined from the insurance-related determination(s) made at block 520. For instance, if the determinations made at block 520 are the example tables 300, 400 of FIGS. 3 and 4, the perils may be fire damage, water damage, and wind damage. And the priority scores may be determined for each peril based upon the values in the tables 300, 400. For example, the fire damage peril priority score may be determined by multiplying the probability of fire damage by the estimated average cost of fire damage. Subsequently, the insights (which are labeled by peril) may be ranked according to the priority scores. Moreover, because the values in tables 300, 400 were determined by the ML model, the insights were effectively ranked using the ML model. Therefore, because the techniques described herein improve the accuracy of the ML model, the techniques described herein also effectively improve the insight ranking.

In other embodiments, each retrieved insight has an associated insight score (e.g., retrieved along with the insights), and the insight are ranked according to the insight scores.

In some embodiments, the ML model directly ranks the insight(s).

At block 524, the one or more processors 120 determine insight(s) (e.g., for presentation to the customer 151, etc.) from the retrieved and/or ranked insights. For example, in some embodiments, the ML model may determine a most probable peril of the customer (e.g., wind damage, as in the example of FIG. 3). Subsequently, the insights associated with the most probable peril may be presented to the customer 151 for customer selection.

In some embodiments, the ML model determines a single insight from the library of insights. For example, the ML model may select, from the insights associated with the most probable peril, an insight with the highest insight score to be the determined single insight.

In some implementations, the ML model directly determines the insight(s).

In some embodiments, the insight(s) are determined by taking a predetermined number of the highest ranked insights (e.g., the two highest ranked insights, the three highest ranked insights, etc.).

In some variations, the insight is determined by selecting the insight with the highest insight score (e.g., without the use of AI and/or ML).

At decision block 526, the one or more processors 120 determine if an update to the customized training dataset is triggered (e.g., determine if an update to the customized training dataset should be made).

For example, if a new insurance customer is added, an update may be triggered. To make such an update, the exemplary process 500 may return to block 504. There, the one or more processors 120 may receive a new base insurance dataset including the additional insurance customer. Additionally or alternatively, the one or more processors 120 may receive information of the additional customer and append it to the base insurance dataset and/or the customized training dataset (advantageously, this saves bandwidth because the entire base insurance dataset does not need to be retransmitted).

In another example, an update may be triggered if a new insurance claim is placed by an insurance customer. In this example, the exemplary process 500 may return to block 504 where a new base insurance dataset including the insurance claim and associated insurance claim information may be received. Additionally or alternatively, the one or more processors 120 may receive the insurance claim and associated insurance claim information, which may then be appended to the base insurance dataset and/or the customized training dataset (advantageously, this saves bandwidth because the entire base insurance dataset does not need to be retransmitted).

In yet another example, the one or more processors 120 may receive a prediction of a severe upcoming weather condition (e.g., a hailstorm, a tornado, a snowstorm, a thunderstorm, a hurricane, a tsunami, etc.) corresponding to the geographic location of the customer. The update may then be triggered in response to receiving the prediction of the severe upcoming weather condition.

At block 528, the one or more processors 120 may present the insurance-related determination(s) and/or insight(s). The presentation may be made at any suitable device, such as at the computing device 102, the customer device 152, 162, 172, the smart device 153, 163, 173, the device of the contractor 199, etc. The presentation may be visual, such as on a display of any of these device(s). The presentation may additionally or alternatively be auditory and/or haptic.

In some examples, the presentation is made as a table. For instance, the example table(s) 300, 400 of FIG. 3-4 may be displayed on a display device, such as display device 129, display(s) of the customer device 152, 162, 172, display(s) of the smart device 153, 163, 173, a display of the device of the contractor 199, etc.

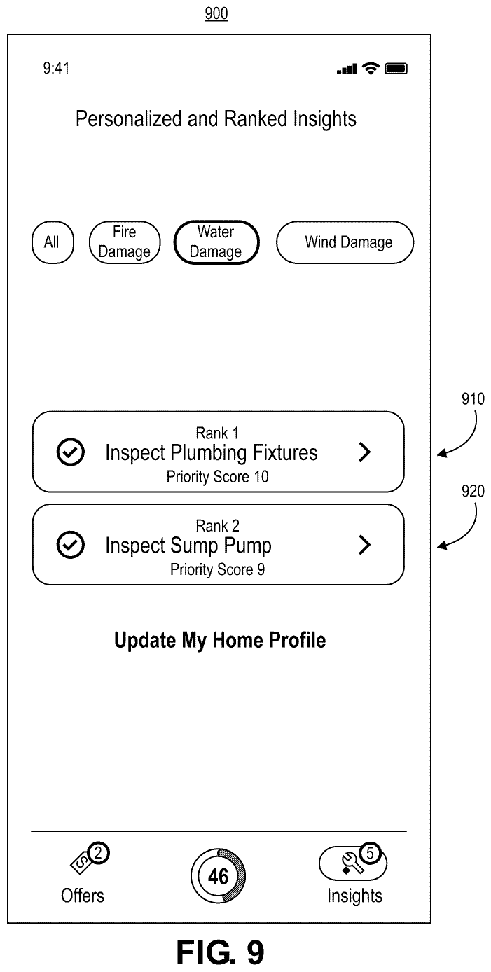

In another example, FIG. 9 depicts an exemplary screen 900 depicting ranked insights 910, 920 (e.g., displayed at any of the display(s) mentioned above, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

Exemplary Building and/or Updating of the Customized Training Dataset and/or the AI and/or ML Model

The following section will describe building of the customized training dataset, and/or the AI and/or ML model. Furthermore, as discussed above with respect to decision block 526 of FIG. 5, the ML model may be updated in response to certain triggers. As will be seen, the updating addresses the technical problem of drift (e.g., where the statistical properties of the data change of time, leading to a mismatch between the model's training dated and the current data it processes). Examples of drift include sudden drift, gradual drift, recurring drift and incremental drift. By addressing the problem of drift the updating advantageously solves a technical problem, thereby improving technical functioning.

In some examples described herein, the updating is accomplished via Bayesian mixture distribution(s). Bayesian mixture distributions provide a flexible and adaptive mechanism for incorporating the inherent structure of observed data (e.g., included in the base insurance dataset and/or customized training dataset) into the modeling process. Given a sufficient number of components, a finite mixture distribution may estimate any probability distribution to an arbitrary level of precision. The general class of mixture models considered here is defined by the likelihood p(xₜ₊₁|Zₜ₊₁|zₜ, θ), the allocation of observations (e.g., included in the base insurance dataset and/or customized training dataset) to mixture components up to time t given as z^{t}, and a mixture kernel parameter prior(s) p(θ). The sequential process of observing new observations, allocating observed observations to mixture components, and updating mixture kernel parameter estimates form a state space with observation equation and evolution of states such that

$${x}_{t + 1} = f ( {z}_{t + 1} , θ )$$

is the observational equation defining the updating sampling distribution given each new observation, and

$${z}_{t + 1} = g ( {z}^{t} θ )$$

defines the allocation of newly observed observations to mixture components.

Techniques described herein address the joint problem of feature engineering and drift using Bayesian mixtures. Below is a brief introduction to Bayesian mixture distributions, particularly for the finite case.

Finite mixtures may be characterized by the assumption of a fixed, finite number of k components, sufficient for characterizing a given data stream's inherent structure. Fitting a finite mixture distribution to a data stream may be performed using methods such as the Expectation-Maximization (EM) algorithm, Gibbs sampler, Metropolis-Hastings sampler, the Hamiltonian Monte Carlo method, or particle filter methodologies such as Parameter Learning.

A quantity x is said to be modeled by a finite q component mixture if

$$\begin{matrix}p ( x \vert γ ) = {\sum }_{j = 1}^{q} {π}_{j} {p}_{j} ( x \vert {θ}_{j} ) \\ Given γ = ( {θ}_{1} , … , {θ}_{q} , {π}_{1} , … , {π}_{q} ) \vert , {π}_{j} > 0 for j = 1 , … , q , and {\sum }_{j = 1}^{q} {π}_{1} = 1 .\end{matrix}$$

For continuous distributions, the point density function pⱼ is parameterized by θⱼ, where

$${\{ θ \}}_{j = 1}^{p}$$

may snare a common component. Using Bayes rule, the posterior distribution of γ is

$$p ( γ \vert {x}^{n} ) ∝ p ( γ ) {\underbrace{{\prod }_{i = 1}^{n} ( {\sum }_{j = 1}^{q} {π}_{j} {p}_{j} ( x \vert {θ}_{j} ) )}}_{Likelihood}$$

with posterior predictive of xₙ₊₁ as

$$p ( {x}_{n + 1} \vert {x}^{n} ) = \int p ( {x}_{n + 1} \vert γ , {x}^{n} ) p ( γ \vert {x}^{n} ) d γ$$

such that xⁿ=(x₁, . . . , xₙ) are observed values of the data stream up to time t=n.

In order to decompose p(γ|xⁿ), the common approach is to introduce a latent allocation vector zᵢ for each xᵢ such that observation i is classified to mixture component j when zᵢ=j. Then,

$$p ( γ \vert {x}^{n} , {z}^{n} ) ∝ p ( γ , {x}^{n} , {z}^{n} ) = p ( γ ) p ( {x}^{n} , {z}^{n} \vert γ )$$

If, in addition, p(γ) is decomposed into components using the Dirichlet, a multivariate generalization of the Beta distribution, the prior may be written as

$$p ( γ ) = p ( π ) {\prod }_{j = 1}^{q} p ( {θ}_{j} ) given {z}_{i} = j$$

and obtain the posterior distribution of γ

$$p ( γ \vert {x}^{n} , {z}^{n} ) ∝ p ( γ , {x}^{n} , {z}^{n} ) = p ( γ ) p ( {x}^{n} , {z}^{n} \vert γ ) = p ( π ) {\prod }_{j = 1}^{q} p ( {θ}_{j} ) {\prod }_{i = 1}^{n} p ( {z}_{i} \vert π ) {\prod }_{i : {z}_{i = j}} {p}_{j} ( {x}_{i} \vert {θ}_{j} )$$

Causal relationships among the distribution of mixing weights p(π) component assignments p(zᵢ|π), and sampling distribution p(xᵢ|θⱼ) over observations with arrows indicating effects are summarized as an example Directed Acyclic Graph (DAG) in FIG. 6.

As shown in FIG. 6, given mixing weights over components

$$π = {\{ {π}_{j} \}}_{j = 1}^{q} such that {\sum }_{j = 1}^{q} {π}_{j} = 1 ,$$

observation component memberships at time t are summarized as p(zᵢ|π). Given sampling distribution kernel parameters

$$θ = {\{ {θ}_{j} \}}_{j = 1}^{q} ,$$

the sampling distribution of each component is then expressed as pⱼ(xᵢ|θj))_{i:z}_{ᵢ}₌ⱼ.

Insurance Examples. In some implementations discussed herein the above-discussed conditional probability distribution p(x|γ) may be the customized training dataset. For instance, in one example, the base insurance dataset may be p(x). Then, removing data from the base insurance dataset based upon respective geographic distances between the geographic location of the customer and respective insurance customers of the plurality of insurance customers may, for example, condition the dataset based upon the respective geographic distances. Advantageously, the conditioned dataset p(x|y) may then be used to train the ML model.

Additionally or alternatively, removing data from the base insurance dataset based upon the temporal constraint also may build the conditional probability distribution p(x|γ) (e.g., a probability distribution conditioned upon the temporal constraint).

Exemplary Adaptive Mixture Features (AMF) techniques. Techniques described herein may apply a transformation method that leverages the structure of each predictor to aid in the construction of a ML model. Bayesian mixture distributions may describe a data stream up to an arbitrary level of precision with component structures updated via sufficient statistics as new data is observed (and/or the ML model is updated following decision block 526). Covariate shift and real concept drift are issues in machine learning that degrade the predictive performance of a given machine learning solution. Bayesian mixtures described herein may provide an effective method of data transformation utilizing the structure of the data to aid in a ML model's predictive performance by uncovering potential directions of low variance and high correlation. Additionally, utilizing calculated features of fitted mixtures (such as the inverse cumulative distribution transform and updating of sufficient statistics as new data is seen post model fit) may also provide a means for constructing flexible, stable and adaptive machine learning model solutions that exhibit a higher resilience to the negative effects of drift compared to existing methods.

Techniques described herein introduce a model-agnostic approach to counteract the negative effects of drift, using data structures denoted as Ψₓ, which are calculated from fitted mixtures. This approach advantageously allows the flexible, underlying sub-component structure Ψₓ to be fit individually to each xⱼ ∈ X, decomposing a single column of data into its respective sub-component structures, extending feature engineering to the one-to-many case.

Techniques described herein incorporate the distribution of [symbol] _{x,y} into the machine learning modeling process as calculated features of the data. Transformations, such as those discussed elsewhere herein, may then additionally be evaluated for improving model performance. Mixture features may provide an extended tool-set for performing feature engineering and may provide additional information for the tracking of assumed distributional changes that signify an updating of a particular ensembles for the ML model.

Bayes rule provides a flexible framework for modeling structures through the use of mixture distributions with online updating via sufficient statistics. As discussed herein, by decomposing inherent data structures, mixture distributions provide an efficient mechanism for combating model degradation due to gradual covariate shift and concept drift.

As will be discussed in the following paragraph, mixture features, ξ_{x,y}, are calculated transformations of [symbol] _{x,y}, given fitted mixture distributions, that allow data to be adaptive. These transformations also allow an otherwise static ML model when fit on ξ_{x,y} o be adaptive as well. Details are provided starting with the following paragraph. This point is not trivial. As data structures may evolve through time, allocation of new observations to mixture components and updating of resulting sufficient statistics provide a continuous mechanism for the evaluation and use of Ψₓ.

Techniques discussed herein incorporate the structure of a given dataset by implementing Bayes rule. The distributional structure of the data S_{(φ≡(x,y))} is modeled using mixtures independently over variates such that

$${S}_{( ϕ )} = \{ p ( {ϕ}_{j} \vert {γ}_{j} ) = {\sum }_{l = 1}^{{q}_{( j )}} {π}_{l} {p}_{l} ( {ϕ}_{l} \vert {θ}_{l} ) , {γ}_{j} = ( {\{ π \}}_{j = 1}^{q ( j )} , {\{ θ \}}_{j = 1}^{q ( j )} ) \}$$

Then, observed data values are replaced with features ξ_{φ1}, which are evaluated at each data sample such that ξ_{φj}=H(φⱼ, γⱼ), where H is a scalar function (e.g. CDF, PDF, . . . ). ξ_{φj} are created from mixture fits, where fits are updated as new observations are allocated to components helping to combat drift.

When updating features of mixture fits for each newly observed x_{j,t+1} the updating process performs a simple allocate-update-learn procedure as a state space. First, each newly observed x_{j,t+1}|p(xₙ₊₁|xⁿ) is allocated to an existing mixture component. Second, corresponding sufficient statistics

$$( {Z}_{j , t + 1} ) = ( {\{ π \}}_{l = 1}^{q ( j )} , {\{ S \}}_{l = 1}^{q ( j )} )$$

are updated component-wise given each new allocation. And, third, new mixture features ξ_{φ}_{ⱼ}ₜ₊₁|(x_{j,t+1}, Z_{j,t+1}) are calculated given the updated fits.

Exemplary Notation. Expanding notation to include individual component level features, we define now for each xⱼ ∈ X

$${ξ}_{j , \cdot , t} = H ( {ϕ}_{j} , {γ}_{j} )$$

As the resulting calculated data feature given the full fitted qⱼ component mixture for variate φⱼ at time=t. Given each individual fitted component, we can then define

$${ξ}_{j , l , t} = H ( {ϕ}_{j} , {γ}_{lj} )$$

as component level mixture features, resulting in

$${ξ}_{{ϕ}_{j}} = \{ {ξ}_{j , \cdot , t} , {ξ}_{j , l = 1 , t} , … , {ξ}_{j , l = q ( j ) , t} \}$$

$$and$$

$${ξ}_{x} = {\{ {ξ}_{{ϕ}_{j}} \}}_{j = 1}^{p} ,$$

$$such that$$

$${D}_{x , y} : \to {D}_{{ξ}_{x} , {ξ}_{y}}$$

is an extended data vector.

Exemplary Adaptive Mixture Features (AMF) Implementation. An exemplary flowchart depicting fitting, updating and evolving mixture features according to the AMF methodology is provided in FIG. 7. The AMF process consists of two main phases: a model build phase and a model adoption phase, as shown in FIG. 2. The model build phase of AMF may include, in addition to a data science model build, a multi-step feature engineering approach. Feature engineering given AMF may include the fitting of mixture distributions to each predictor, allocation of observations to mixture components, calculation of mixture features of the fitted mixtures, and transformation of the observed predictor set to a transformed predictor set, as depicted on the left-hand pane 710 of FIG. 7. For the model build phase, data degeneracy is considered a tuning parameter of the machine learning model by choosing a recent window of k observations (e.g., (t−k)*, etc.), possibly at multiple change points within the data stream. Mixtures are then fit to each individual xⱼ ∈ X as given in the above Fit Mixture step, and subsequent sufficient statistics Z are summarized over components. Given a user chosen function of the fitted distributions, H_{x,y}, observed data values are then transformed as [symbol] x,y→ [symbol] _{ξxξy} prior to fitting the ML model.

As shown on the right-hand pane 720 of FIG. 7, the model adoption phase of AMF is performed as new observations are seen post model fit. As new observations (e.g., updates following a “yes” at decision block 526 of FIG. 5) are presented for model scoring, each predictor level mixture is updated through the allocation of observations to mixture components with resultant updating of sufficient statistics Zₜ→Z_{t+Δ} performed according to adaptive weights, ω₆₆ _{ⱼ}.

Given Hₓ, newly observed observations are then transformed X_{t+Δ}→ξ_{xt+Δ} and presented to the ML model for prediction.

A conjecture. Mixture features are a hypothesized application of Shannon-Khinchin axioms. Given a probability distribution p(x), Shannon entropy is defined as

$$S ( p ) = - {\sum }_{i = 1}^{n} p ( {x}_{i} ) log p ( {x}_{i} )$$

By axiom 4 of Shannon-Khinchin axioms, S(p) is separable, considering a joint distribution R=p(x₁, . . . , x_{q}). We can then consider a mixture distribution p(x|y)=

$${\sum }_{k = 1}^{q} {π}_{k} {p}_{k} ( x \vert {θ}_{k} )$$

as samples nom the joint p(x₁, x₂, . . . , x_{q}) with marginals

$${p ( x )}_{k} = ( p ( {x}_{1} ) , … , p ( {x}_{nk} ) ) , k ∈ ( 1 , … , q )$$

Then by Axiom 4,

$$S ( R ) = {\sum }_{k = 1}^{q} {\sum }_{k \neq j} S ( {x}_{k} ) + S ( {x}_{j} \vert {x}_{k} ) , \qquad ∀ j \neq k$$

Considering mixture features for each xⱼ ∈ X, ξₓⱼ={ξ_{j;t}, ξ_{j,k=1,t} . . . , ξ_{j,k=q,t}} may distribute the Shannon entropy S(xⱼ) of observing xⱼ given the response Y for each

$${ξ}_{{x}_{j}} ∈ {\{ {ξ}_{{x}_{j}} \}}_{j = 1}^{p}$$

subject to ML model selection. As discussed elsewhere herein with respect to Multivariate Gaussian Mixtures, when used as engineered data features, ξₓ_{ⱼ}, may be useful for improving predictive model performance due to the resultant, additive decomposition of entropy from within a single column of data xⱼ ∈ X.

Sequential Component Structures. As a natural extension of the introduced data structure, {ξₓ, Ψₓ}, considering sequential time, we define {ξₓ, Ψₓ}ₜ as time dependent mixture features, describing a given data stream referenced up to a specific point in time. As described herein, a diversion may be taken from the common “method” approach of constructing increasingly complex ML solutions to minimize entropy, and instead propose a universal “data” approach incorporating evolving data structures, {ξₓ, Ψₓ}ₜ into the modeling process, with inherent scale-ability.

Multivariate Gaussian Mixtures. Consider a finite multivariate Gaussian mixture such that

$$p ( ω ) = {\sum }_{k = 1}^{n} {π}_{k} N ( ω \vert {μ}_{k} , {\sum }_{k} )$$

$$and ,$$

$${\sum }_{k = 1}^{n} {π}_{k} = 1 and ω = ( {x}_{1} , … , {x}_{d - 1} , y ) .$$

Solving for the conditional distribution

$$p ( y \vert x ) = p ( y \vert {x}_{1} , … , {x}_{d - 1} ) = \frac{p ( y \cdot x )}{p ( x )} = {\sum }_{k = 1}^{n} \frac{{π}_{k}}{p ( x )} N ( ω \vert {μ}_{k} , {\sum }_{k} )$$

$$Assuming that$$

$$μ = ( {μ}_{y} , {μ}_{x} ) and \sum = [ \begin{matrix}{\sum }_{yy} & {\sum }_{yx} \\ {\sum }_{xy} & {\sum }_{xx}\end{matrix} ] .$$

Now solve for the conditional

$$N ( y \vert x , μ , \sum ) = N ( y \vert {μ}_{y \vert x} , {\sum }_{y \vert x} )$$

$$Where$$

$${μ}_{y \vert x} = {μ}_{y} + {\sum }_{yx} {\sum }_{yy}^{- 1} ( y - {μ}_{y} ) and {\sum }_{y \vert x} = {\sum }_{yy} - {\sum }_{yx} {\sum }_{xx}^{- 1} {\sum }_{xy}$$

as well as

$$p ( x ) = {\sum }_{k = 1}^{n} {π}_{k} N ( x \vert {μ}_{k , x} , {\sum }_{k , xx} )$$

Given the above, then

$$p ( y \vert x ) = {\sum }_{k = 1}^{n} \frac{{π}_{k}}{p ( x )} N ( ω \vert {μ}_{k} , {\sum }_{k} ) = {\sum }_{k = 1}^{n} \frac{{π}_{k} N ( ω \vert {μ}_{k} , {\sum }_{k} )}{p ( x )}$$

Solving for the conditional distribution

$$p ( y \vert x ) = {\sum }_{k = 1}^{n} ( \frac{{π}_{k} N ( x \vert {μ}_{k , x} , {\sum }_{k , xx} )}{{\sum }_{l = 1}^{n} {π}_{l} N ( x \vert {μ}_{l , x} {\sum }_{l , xx} )} ) * N ( y \vert {μ}_{k , y \vert x} , {\sum }_{k , y \vert x} )$$

Therefore, the conditional is then also a mixture distribution defined by p(y|x)˜N(y|μ_{k,y|x}, Σ_{k,y|x}) with mixing weights

$${pi}_{k , y \vert x} = \frac{{π}_{k} N ( x \vert {μ}_{k , x} , {\sum }_{k , xx} )}{{\sum }_{l = 1}^{n} {π}_{l} N ( x \vert {μ}_{l , x} , {\sum }_{k , xx} )} .$$

Updating of the conditional Gaussian mixtures may be extended by the allocation of newly observed observations to components through the posterior predictive p(xₜ₊₁|xₜ). Updating may be performed with updated mixture features ξ_{j,t+1} according to the following observe-allocate-update process of the d dimensional Dirichlet process multivariate Gaussian mixture model.

The Dirichlet Gaussian mixture is parameterized by the following mixture of distributions

$$f ( {x}_{t} ; G ) = \int N ( {x}_{t} \vert {μ}_{t} , {\sum }_{t} ) \partial G ( {μ}_{t} , {\sum }_{t} )$$

given G˜DP(α,G₀(μξ))

The concentration parameter

$$α \sim {α}_{x} , \frac{{μ}_{x}}{{α}_{x}}$$

which governs the “bumpiness” of the draws from G₀ such that,

$${G}_{0} = N ( μ , λ , \sum ) and W ( {\sum }^{- 1} ; v , Ω ) .$$

Quantity W(Σ⁻¹; v, Ω) is the conjugate Wishart distribution such

$$ε ( \sum ) = \frac{Ω}{( v - ( d + 1 ) ) / 2} .$$

Updated sufficient statistics as new data is observed is denoted by ξ=(sₜ, nₜ, kₜ) where sₜ are the conditional sufficient statistics of the mixture components and nₜ is the number of observations allocated to each component, kₜ is the number of components. The predictive density for updating is provided by

$$p ( {x}_{t + 1} \vert {ζ}_{t} ) = \frac{α}{α + 1} T ( {x}_{t + 1} ; {α}_{0} , {β}_{0} , {c}_{0} ) + {\sum }_{j = 1}^{m} t \frac{{n}_{t} , j}{α + t} T ( {y}_{t + 1} , {α}_{t , j} , {β}_{t , j} , {c}_{t , j} )$$

$$Such that ,$$

$${α}_{0} = λ$$

$${β}_{0} = \frac{2 ( k + 1 )}{k {c}_{0}} Ω$$

$${c}_{0} = 2 v - d + 1$$

$${α}_{t , j} = \frac{k α + {n}_{t} {\overline{y}}_{t , j}}{k + {n}_{t , j}}$$

$${β}_{t , j} = \frac{2 ( k + {n}_{t , j} + 1 )}{( k + {n}_{t , j} ) {c}_{t , j}} ( Ω + 0.5 {D}_{t , j} )$$

$${c}_{t , j} = 2 v + {n}_{t , j} - d + 1$$

$${D}_{t , j} = {S}_{t , j} + \frac{{kn}_{t , j}}{k + {n}_{t , j}} ( α - {\overline{y}}_{t , j} ) ( λ - {\overline{y}}_{t , j} )$$

Exemplary AI and/or ML Techniques for Making an Insurance-Related Determination

In some embodiments, AI and/or ML algorithm(s) and/or model(s) may be used to partially or wholly to make the insurance-related determination(s). Although the following discussion refers to an ML algorithm, it should be appreciated that it applies equally to ML and/or AI algorithms and/or models.

FIG. 8 is a block diagram of an exemplary machine learning modeling method 800 for training and evaluating a ML model, in accordance with various embodiments. In some embodiments, the model “learns” an algorithm capable of performing the desired function, such as making an insurance-related determination. It should be understood that the principles of FIG. 8 may apply to any ML algorithm discussed herein.

Although the following discussion refers to the blocks of FIG. 8 as being performed by the one or more processors 120, it should be appreciated that the blocks of FIG. 8 may be performed by any suitable component or combinations of components (e.g., one or more processors of any of the customer devices 152, 162, 172, etc.).

At a high level, the machine learning modeling method 800 includes a block 810 to prepare the data, a block 820 to build and train the model, and a block 830 to run the model.

Block 810 may include sub-blocks 812 and 816. At block 812, the one or more processors 120 may receive the historical information to train the ML model. In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the insurance related determinations that the ML model is trained to determine. Examples of these include historical: (i) probabilities of a loss by cause of loss, (ii) cost estimates by cause of loss, (iii) probabilities of loss by loss-comment-code, (iv) indemnity estimates by loss-comment-code, (v) percent changes in probability of loss given a performed insight, (vi) probabilities that customer will perform an insight, (vii) estimated costs of performed insights, (viii) customer segmentations, (ix) probabilities of a customer placing an insurance claim, and/or (x) insights.

The independent variables are used to determine the dependent variables. Put another way, the independent variables may have an impact on the dependent variables; and the ML algorithms may be trained to find this impact. Therefore, when using a trained ML algorithm to make an insurance-related determination, information corresponding to the historical information that the ML was trained on may be routed into the ML algorithm to make the insurance-related determination. Examples of the independent variables include historical: information of insurance customers (optionally anonymized) (e.g., geographic locations of insured properties of insurance customers [e.g., longitude/latitude coordinates, addresses, etc.]; probabilities of insurance customers to complete insights; information of insured properties of the insurance customers; demographic information of insurance customers; etc.), insurance claim information, insurance policy information, etc.

The historical information may be received from any suitable source. Examples of sources that any of the historical information may be received from include: the memory 122, internal database 118, the external database 180, the smart devices 153, 163, 173, etc. It should be appreciated that the historical information may be received from combinations of these sources as well.

Block 820 may include sub-blocks 822 and 826. At block 822, the machine learning (ML) model is trained (e.g. based upon the data received from block 810). In some embodiments where associated information is included in the historical information, the ML model “learns” an algorithm capable of calculating or predicting the target feature values (e.g., making the insurance-related determination, etc.) given the predictor feature values.

At block 826, the one or more processors 120 may evaluate the machine learning model, and determine whether or not the machine learning model is ready for deployment.

Further regarding block 826, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

Moreover, it should be appreciated the ML algorithm may be any kind of ML algorithm (e.g., neural network, convolutional neural network, deep learning algorithm, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments

In one aspect, a computer-implemented method for training and/or using a machine learning (ML) model to make an insurance-related determination may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) constructing, via one or more processors, a customized training dataset by: (A) receiving a geographic location of a customer; (B) receiving a base insurance dataset including data of a plurality of insurance customers; and/or (C) building the customized training dataset by removing data from the base insurance dataset based upon: (i) respective geographic distances between the geographic location of the customer and respective insurance customers of the plurality of insurance customers, and/or (ii) a temporal constraint; (2) training, via the one or more processors, the ML model by inputting the customized training dataset into the ML model; and/or (3) determining, via the one or more processors, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim. The method may include additional, fewer, or alternate actions, including those discussed elsewhere herein.

In some embodiments, the building the customized training dataset by removing data from the base insurance dataset forms a conditional probability distribution, and/or the customized training dataset comprises the conditional probability distribution; the training the ML model by inputting the customized training dataset into the ML model comprises inputting the conditional probability distribution into the ML model; and/or the ML model comprises a Multivariate Gaussian Mixture model or a Bayesian model.

In certain embodiments, the geographic location of the customer may include a longitude and/or latitude; geographic locations of the respective insurance customers may include respective longitudes and/or latitudes; and/or the respective geographic distances are set to haversine distances between the geographic location of the customer and the geographic locations of the respective insurance customers.

In various embodiments, the computer-implemented method may further include retrieving, via the one or more processors, a library of insights; and/or determining, via the one or more processors, an insight from the library of insights using the trained ML model.

In some embodiments, the computer-implemented method may further include retrieving, via the one or more processors, a library of insights; ranking, via the one or more processors, insights from the library of insights using the trained ML model; and/or presenting, via the one or more processors, for selection by the customer, on a display, the ranked insights.

In certain embodiments, the computer-implemented method may further include retrieving, via the one or more processors, a library of insights, wherein insights of the library of insights are grouped by peril; determining, via the one or more processors, a most probable peril of the customer using the trained ML model; and/or presenting, via the one or more processors, for selection by the customer, on a display, a group of retrieved insights corresponding to the determined most probable peril.

In various embodiments, the computer-implemented method may further include retrieving, via the one or more processors, a library of insights, wherein insights of the library of insights are grouped by peril; determining, via the one or more processors, a priority score for each peril group using the trained ML model; and/or presenting, via the one or more processors, for selection by the customer, on a display: (i) a group of insights corresponding to a particular peril, and (ii) a priority score of the particular peril.

In some embodiments, the building the customized training dataset may further include, subsequent to the removing the data from the base insurance dataset, creating an empirical cumulative distribution function (ECDF) from the customized training dataset; and/or the inputting the customized training dataset into the ML model comprises inputting the ECDF into the ML model.

In certain embodiments, the computer-implemented method may further include triggering, via the one or more processors, updating of the customized training dataset based upon (i) addition of a new insurance customer to the plurality of insurance customers, and/or (ii) a new insurance claim being placed by an insurance customer of the plurality of insurance customers.

In various embodiments, the computer-implemented method may further include receiving, via the one or more processors, a prediction of a severe upcoming weather condition corresponding to the geographic location of the customer; and/or in response to the receiving of the prediction of the severe upcoming weather condition, triggering, via the one or more processors, updating of the customized training dataset.

In another aspect, a computer device configured for training and/or using a machine learning (ML) model to make an insurance-related determination may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) construct a customized training dataset by: (A) receiving a geographic location of a customer; (B) receiving a base insurance dataset including data of a plurality of insurance customers; and/or (C) building the customized training dataset by removing data from the base insurance dataset based upon: (i) respective geographic distances between the geographic location of the customer and respective insurance customers of the plurality of insurance customers, and/or (ii) a temporal constraint; (2) train the ML model by inputting the customized training dataset into the ML model; and/or (3) determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim. The computer device may include additional, less, or alternate functionality, including that discussed elsewhere herein.

In some embodiments, the building the customized training dataset by removing data from the base insurance dataset forms a conditional probability distribution, and/or the customized training dataset comprises the conditional probability distribution; the one or more processors are further configured to train the ML model by inputting the customized training dataset into the ML model by inputting the conditional probability distribution into the ML model; and/or the ML model comprises a Multivariate Gaussian Mixture model or a Bayesian model.

In certain embodiments, the geographic location of the customer may include a longitude and/or latitude; geographic locations of the respective insurance customers may include respective longitudes and/or latitudes; and/or the respective geographic distances are set to haversine distances between the geographic location of the customer and the geographic locations of the respective insurance customers.

In various embodiments, the one or more processors are further configured to: retrieve a library of insights; and/or determine an insight from the library of insights using the trained ML model.

In some embodiments, the one or more processors are further configured to: build the customized training dataset by, subsequent to the removing the data from the base insurance dataset, creating an empirical cumulative distribution function (ECDF) from the customized training dataset; and/or input the customized training dataset into the ML model by inputting the ECDF into the ML model.

In yet another aspect, a computer system configured for training and/or using a machine learning (ML) model to make an insurance-related determination may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) construct a customized training dataset by: (A) receiving a geographic location of a customer; (B) receiving a base insurance dataset including data of a plurality of insurance customers; and/or (C) building the customized training dataset by removing data from the base insurance dataset based upon: (i) respective geographic distances between the geographic location of the customer and respective insurance customers of the plurality of insurance customers, and/or (ii) a temporal constraint; (2) train the ML model by inputting the customized training dataset into the ML model; and/or (3) determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim. The computer system may include additional, less, or alternate functionality, including that discussed elsewhere herein.

In some embodiments, the building the customized training dataset by removing data from the base insurance dataset forms a conditional probability distribution, and/or the customized training dataset comprises the conditional probability distribution; the one or more non-transitory memories have stored thereon computer-executable instructions that, when executed by the one or more processors, further cause the one or more processors to train the ML model by inputting the customized training dataset into the ML model by inputting the conditional probability distribution into the ML model; and/or the ML model comprises a Multivariate Gaussian Mixture model or a Bayesian model.

In certain embodiments, the geographic location of the customer may include a longitude and/or latitude; geographic locations of the respective insurance customers may include respective longitudes and/or latitudes; and/or the respective geographic distances are set to haversine distances between the geographic location of the customer and the geographic locations of the respective insurance customers.

In various embodiments, the one or more non-transitory memories having stored thereon computer-executable instructions that, when executed by the one or more processors, may further cause the one or more processors to: retrieve a library of insights; and/or determine an insight from the library of insights using the trained ML model.

In some embodiments, the one or more non-transitory memories having stored thereon computer-executable instructions that, when executed by the one or more processors, may further cause the one or more processors to: build the customized training dataset by, subsequent to the removing the data from the base insurance dataset, creating an empirical cumulative distribution function (ECDF) from the customized dataset; and/or input the customized training dataset into the ML model by inputting the ECDF into the ML model.

In certain embodiments, an insight is a recommendation to: complete a home improvement project, learn a homeowner skill, inspect a feature of a home (e.g., pluming, HVAC, etc.), and/or perform home maintenance.

### Additional Machine Learning Aspects

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors), and/or via computer-executable instructions stored on non-transitory computer-readable media or medium.

In some embodiments, the server computing device is configured to implement machine learning, such that server computing device “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of attributes with known characteristics or features. Such information may include, for example, information associated with a plurality of IoT devices.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, in some embodiments, the processing element may learn how to identify characteristics and patterns that may then be applied to analyzing and classifying objects. The processing element may also learn how to identify attributes of different objects in different lighting. This information may be used to determine which classification models to use and which classifications to provide.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for training and using a machine learning (ML) model to make an insurance-related determination, the computer-implemented method comprising:
constructing, via one or more processors, a customized training dataset by:
receiving a geographic location of a customer;
receiving a base insurance dataset including data of a plurality of insurance customers; and
building the customized training dataset by removing data from the base insurance dataset based upon: (i) respective geographic distances between the geographic location of the customer and respective insurance customers of the plurality of insurance customers, and (ii) a temporal constraint;
training, via the one or more processors, the ML model by inputting the customized training dataset into the ML model; and
determining, via the one or more processors, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim.

2. The computer-implemented method of claim 1, wherein:
the building the customized training dataset by removing data from the base insurance dataset forms a conditional probability distribution, and the customized training dataset comprises the conditional probability distribution;
the training the ML model by inputting the customized training dataset into the ML model comprises inputting the conditional probability distribution into the ML model; and
the ML model comprises a Multivariate Gaussian Mixture model or a Bayesian model.

3. The computer-implemented method of claim 1, wherein:
the geographic location of the customer includes a longitude and latitude;
geographic locations of the respective insurance customers include respective longitudes and latitudes; and
the respective geographic distances are set to haversine distances between the geographic location of the customer and the geographic locations of the respective insurance customers.

4. The computer-implemented method of claim 1, further including:
retrieving, via the one or more processors, a library of insights; and
determining, via the one or more processors, an insight from the library of insights using the trained ML model.

5. The computer-implemented method of claim 1, further including:
retrieving, via the one or more processors, a library of insights;
ranking, via the one or more processors, insights from the library of insights using the trained ML model; and
presenting, via the one or more processors, for selection by the customer, on a display, the ranked insights.

6. The computer-implemented method of claim 1, further including:
retrieving, via the one or more processors, a library of insights, wherein insights of the library of insights are grouped by peril;
determining, via the one or more processors, a most probable peril of the customer using the trained ML model; and
presenting, via the one or more processors, for selection by the customer, on a display, a group of retrieved insights corresponding to the determined most probable peril.

7. The computer-implemented method of claim 1, further including:
retrieving, via the one or more processors, a library of insights, wherein insights of the library of insights are grouped by peril;
determining, via the one or more processors, a priority score for each peril group using the trained ML model; and
presenting, via the one or more processors, for selection by the customer, on a display: (i) a group of insights corresponding to a particular peril, and (ii) a priority score of the particular peril.

8. The computer-implemented method of claim 1, wherein:
the building the customized training dataset further includes, subsequent to the removing the data from the base insurance dataset, creating an empirical cumulative distribution function (ECDF) from the customized training dataset; and
the inputting the customized training dataset into the ML model comprises inputting the ECDF into the ML model.

9. The computer-implemented method of claim 1, further including triggering, via the one or more processors, updating of the customized training dataset based upon (i) addition of a new insurance customer to the plurality of insurance customers, and/or (ii) a new insurance claim being placed by an insurance customer of the plurality of insurance customers.

10. The computer-implemented method of claim 1, further including:
receiving, via the one or more processors, a prediction of a severe upcoming weather condition corresponding to the geographic location of the customer; and
in response to the receiving of the prediction of the severe upcoming weather condition, triggering, via the one or more processors, updating of the customized training dataset.

11. A computer device for training and using a machine learning (ML) model to make an insurance-related determination, the computer device comprising one or more processors configured to:
construct a customized training dataset by:
receiving a geographic location of a customer;
receiving a base insurance dataset including data of a plurality of insurance customers; and
building the customized training dataset by removing data from the base insurance dataset based upon: (i) respective geographic distances between the geographic location of the customer and respective insurance customers of the plurality of insurance customers, and (ii) a temporal constraint;
train the ML model by inputting the customized training dataset into the ML model; and
determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim.

12. The computer device of claim 11, wherein:
the building the customized training dataset by removing data from the base insurance dataset forms a conditional probability distribution, and the customized training dataset comprises the conditional probability distribution;
the one or more processors are further configured to train the ML model by inputting the customized training dataset into the ML model by inputting the conditional probability distribution into the ML model; and
the ML model comprises a Multivariate Gaussian Mixture model or a Bayesian model.

13. The computer device of claim 11, wherein:
the geographic location of the customer includes a longitude and latitude;
geographic locations of the respective insurance customers include respective longitudes and latitudes; and
the respective geographic distances are set to haversine distances between the geographic location of the customer and the geographic locations of the respective insurance customers.

14. The computer device of claim 11, wherein the one or more processors are further configured to:
retrieve a library of insights; and
determine an insight from the library of insights using the trained ML model.

15. The computer device of claim 11, wherein the one or more processors are further configured to:
build the customized training dataset by, subsequent to the removing the data from the base insurance dataset, creating an empirical cumulative distribution function (ECDF) from the customized training dataset; and
input the customized training dataset into the ML model by inputting the ECDF into the ML model.

16. A computer system for training and using a machine learning (ML) model to make an insurance-related determination, the computer system comprising:
one or more processors; and
one or more non-transitory memories, the one or more non-transitory memories having stored thereon computer-executable instructions that, when executed by the one or more processors, cause the one or more processors to:
construct a customized training dataset by:
receiving a geographic location of a customer;
receiving a base insurance dataset including data of a plurality of insurance customers; and
building the customized training dataset by removing data from the base insurance dataset based upon: (i) respective geographic distances between the geographic location of the customer and respective insurance customers of the plurality of insurance customers, and (ii) a temporal constraint;
train the ML model by inputting the customized training dataset into the ML model; and
determine, by inputting data of the customer into the trained ML model, one or more of: (i) probability of a loss by cause of loss, (ii) a cost estimate by cause of loss, (iii) probability of loss by loss-comment-code, (iv) indemnity estimate by loss-comment-code, (v) percent change in probability of loss given performed insight, (vi) probability that customer will perform insight, (vii) estimated cost of performed insight, (viii) customer segmentation, and/or (ix) probability of the customer placing an insurance claim.

17. The computer system of claim 16, wherein:
the building the customized training dataset by removing data from the base insurance dataset forms a conditional probability distribution, and the customized training dataset comprises the conditional probability distribution;
the one or more non-transitory memories have stored thereon computer-executable instructions that, when executed by the one or more processors, further cause the one or more processors to train the ML model by inputting the customized training dataset into the ML model by inputting the conditional probability distribution into the ML model; and
the ML model comprises a Multivariate Gaussian Mixture model or a Bayesian model.

18. The computer system of claim 16, wherein:
the geographic location of the customer includes a longitude and latitude;
geographic locations of the respective insurance customers include respective longitudes and latitudes; and
the respective geographic distances are set to haversine distances between the geographic location of the customer and the geographic locations of the respective insurance customers.

19. The computer system of claim 16, the one or more non-transitory memories having stored thereon computer-executable instructions that, when executed by the one or more processors, cause the one or more processors to:
retrieve a library of insights; and
determine an insight from the library of insights using the trained ML model.

20. The computer system of claim 16, the one or more non-transitory memories having stored thereon computer-executable instructions that, when executed by the one or more processors, cause the one or more processors to:
build the customized training dataset by, subsequent to the removing the data from the base insurance dataset, creating an empirical cumulative distribution function (ECDF) from the customized dataset; and
input the customized training dataset into the ML model by inputting the ECDF into the ML model.
